(19) United States
(12) Patent Application Publication
(10) Pub. No.: US 2012/0127276 A1
(43) Pub. Date: May 24, 2012

(54) IMAGE RETRIEVAL SYSTEM AND METHOD AND COMPUTER PRODUCT THEREOF

(76) Inventors: Chi-Hung Tsai, Taichung City (TW); Yeh-Kuang Wu, New Taipei City (TW); Bo-Fu Liu, Tainan City (TW); Chien-Chung Chiu, Yilan County (TW)

(21) Appl. No.: 13/160,906

(22) Filed: Jun. 15, 2011

(30) Foreign Application Priority Data
Nov. 22, 2010 (TW) 99140151

(51) Int. Cl. H04N 13/02; G06K 9/00

(52) U.S. Cl. 348/47; 382/154; 348/E13.074

(57) ABSTRACT

An image retrieval system and method thereof is provided. The method of the image retrieval system has the following steps: capturing an input image of an object simultaneously and separately by dual cameras in a mobile device, obtaining a depth image by the mobile device according to the input images, and determining a target object according to the input images and image features of the depth image, and receiving the target object by an image data server, obtaining retrieving data corresponding to the target object, and transmitting the retrieving data to the mobile device.

### CROSS REFERENCE TO RELATED APPLICATIONS

This Application claims priority of Taiwan Patent Application No. 099140151, filed on Nov. 22, 2010, the entirety of which is incorporated by reference herein.

### BACKGROUND OF THE INVENTION

1. Field of the Invention

The present invention relates to applications of 3D computer vision, and in particular relates to using a mobile device to capture images and perform image retrieving.

2. Description of the Related Art

Recently, mobile device products, such as mini-notebooks, tablet PCs, PDAs, MIDs, or smart phones, have been deployed with image capturing technology for users to take photos or record at anytime. Accordingly, because applications for video and image processing are widely used, some related technologies or products, which use video/image capturing to take images of a specific object, analyze the image content and query related information, have also been developed. However, these technologies primarily use a mobile device or a camera to take 2D photos or images which are transmitted to a remote server. Then, the remote server further performs the background removal and feature extraction of the photos or images for retrieving a specific object by using related technologies, and the specific object is mapped to a large amount of pre-stored image data in the database to find matching data. Because it is very time-consuming and requires huge computation to remove the background and capture the image features of a 2D photo or image and it is not easy to find the specific object correctly, these technologies are only suitable for high performance mobile devices.

Along with the development of multimedia applications and related display technologies, the demand for technologies to produce more specific and realistic images (e.g. stereo or 3D video) has increased. Generally, based on the physiological factors of stereo vision of a viewer, such as vision difference (or binocular parallax) and motion parallax, a viewer can sense synthesized images displayed on a display as being stereo or 3D images.

Currently, general hand-held mobile devices or smart phones only have one camera lens. In order to build a depth image with depth information, two images should be taken at two difference viewing angles of a same scene. However, this is very inconvenient for a user to do so manually, and the created depth images is usually not accurate enough because it is very difficult to get two accurate images at two different viewing angles due to tremor and differences in shooting distances.

Currently, the image retrieval system assembled on mobile devices usually performs data matching and querying in a remote server in a whole image. Thus, it is time-consuming for image retrieval and the accuracy of the image retrieval is not high. Because the whole image is used for matching, all of the objects and related image features of the whole image should be re-analyzed. Thus, it may cause serious burden on the remote server and the remote server may easily obtain erroneous analyzed results due to unclearness of target objects resulting in low accuracy. Because the procedure for analyzing and matching is very time-consuming, it is inconvenient for users and the users have no interest to use due to a long time for acquiring a matching result.

Therefore, the present invention provides a solution to solve the aforementioned problems by using mobile devices with dual camera lenses to obtain a depth image and extract a target object, which is transmitted to an image data server for searching for the target object. The target object can be retrieved quickly because the depth image is captured by the mobile device and the image features of the depth image can be used to retrieve the target object, and the background removing and feature capturing processes for the 2D images do not need to perform. It can be executed at the mobile device with fewer available resources because the mobile device merely transmits the target object to the image data server for retrieval and the amount of transmitted data is low. As a result, when the mobile device is applied for image retrieval, the present invention can solve the problems associated with the whole image being transmitted to the remote server, wherein a large amount of operations is required, so that the burden and processing time of the remote server can be reduced, making it more convenient for users and stimulating usage.

### BRIEF SUMMARY OF THE INVENTION

A detailed description is given in the following embodiments with reference to the accompanying drawings.

An image retrieval system is provided in the invention. The image retrieval system comprises: a mobile device, at least comprising: an image capturing unit, having dual cameras for capturing an input image of an object simultaneously and separately; a processing unit, coupled to the image capturing unit, for obtaining a depth image according to the input images, and determining a target object according to image features of the input images and the depth image; and an image data server, coupled to the processing unit, for receiving the target object, obtaining retrieving data corresponding to the target object, and transmitting the retrieving data to the mobile device.

An image retrieval method is further provided in the invention. The image retrieval method comprises: capturing an input image of an object simultaneously and separately by dual cameras in a mobile device; obtaining a depth image according to the input images, and determining a target object according to the input images and image features of the depth image by the mobile device; and receiving the target object, obtaining retrieving data corresponding to the target object, and transmitting the retrieving data to the mobile device by an image data server.

A computer program product is further provided in the invention. The computer program product is for being loaded into a machine to execute an image retrieval method, which is suitable for dual cameras in a mobile device to capture an input image of an object. The computer program product comprises: a first program code, for obtaining a depth image according to the input images and determining a target object according to the input images and image features of the depth image; and a second program code, for retrieving the target object to obtain a retrieving data and transmitting the retrieving data to the mobile device.

### BRIEF DESCRIPTION OF THE DRAWINGS

The present invention can be more fully understood by reading the subsequent detailed description and examples with references made to the accompanying drawings, wherein:

FIG. 1 illustrates a block diagram of the image retrieval system according to an embodiment of the invention;

FIG. 2 illustrates a chart of the imaging of dual cameras according to an embodiment of the invention;

FIG. 3 illustrates a chart of the keypoint descriptor according to an embodiment of the invention;

FIG. 4 illustrates a flow chart of the SIFT method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

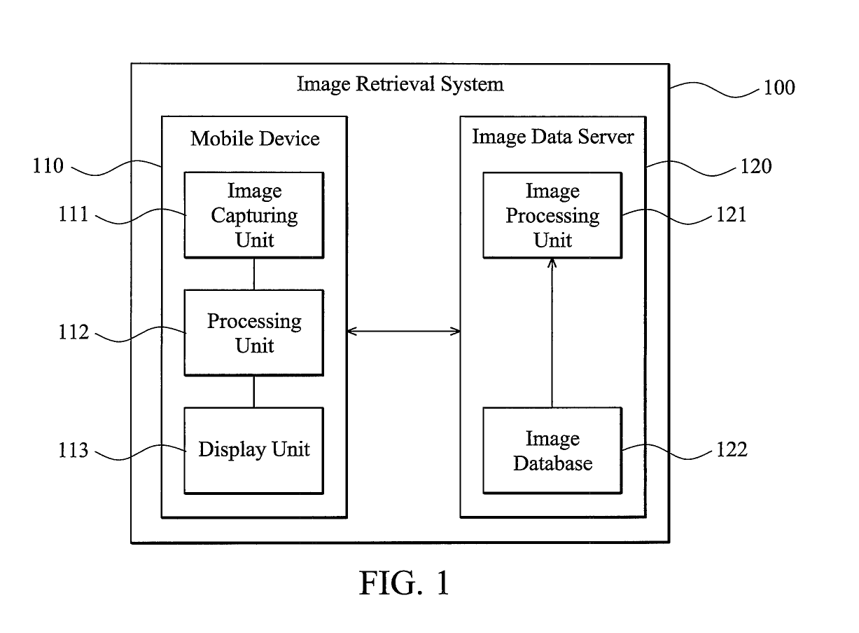

FIG. 1 illustrates a block diagram of the image retrieval system according to an embodiment of the invention. As illustrated in FIG. 1, an image retrieval system 100 for a mobile device is provided. The image retrieval system 100 includes a mobile device 110, and an image data server 120. The mobile device 110 at least includes an image capturing unit 111 and a processing unit 112. In one embodiment, the mobile device 110 can be a hand-held mobile device, a PDA or a smart phone, but the invention is not limited thereto.

In an embodiment, the image capturing unit 111 is a device with dual cameras, including a left camera and a right camera. The dual cameras shoot the same scene in parallel by simulating the vision of human eyes, and capture individual input images from the left camera and the right camera simultaneously and separately. There is binocular parallax between the individual input images captured by the left camera and the right camera, and a depth image can be obtained by using stereo vision technology. The depth generating techniques of stereo vision technology includes block matching algorithms, dynamic programming algorithms, belief propagation algorithms, and graph cuts algorithms, but the invention is not limited thereto. The dual cameras can be adapted from the commercially available products, and the techniques for obtaining the depth image are prior works which is not explained in detail. The processing unit 112, coupled to the image capturing unit 111, may use prior stereo vision technology to obtain a depth image after receiving the individual input images of the dual cameras, and determine a target object according to the image features of the input image and the depth image, wherein details will be explained below. A user can also select one of regions of interest as the target object. The depth image is an image with depth information, which has information of the location in the 2D coordinate (X and Y axis) and information of the depth (Z-axis), and therefore the depth image can be expressed as a 3D image. The image data server 120, coupled to the processing unit 112, receives the target object transmitted as an image from the processing unit 112, retrieves retrieving data corresponding to the target object, and transmits the retrieving data to the mobile device 110. Further, the retrieving data can be data corresponding to the target object or can be no data which means no matching retrieving results.

In another embodiment, the image capturing unit 111 can capture image sequences. On the mobile device 110, the user may use a set of specific buttons (not shown) to control the individual input images captured by the dual cameras in the image capturing unit 111, and may choose and confirm the individual input images of the dual cameras transmitted to the processing unit 112. When the processing unit 112 receives the individual input images of the dual cameras, the processing unit 112 obtains a depth image according to the individual input images of the dual cameras, and calculates the image features of the input images and the depth image to determine a target object from the depth image.

In also another embodiment, the image capturing unit 112 can also capture input image sequences with a single camera, and the processing unit 112 can use a depth image algorithm to generate a depth image.

In one embodiment, the image features of the input images and the depth image can be information of at least one of the depth, area, template, outline and topology features of the object. For determining the target object, the processing unit 112 can choose the foreground object appearing closest to the dual cameras in the depth image as the target object according to the depth information of the depth image, or normalize the image features of the input images and the depth image to determine the target object. The processing unit 112 may also select all candidate foreground objects appearing closer to the dual cameras, calculate the normalized areas of the candidate foreground objects in the input images after normalizing the depth information, and choose the normalized area of the object matching with the pre-stored object area region as the target object. The processing unit 112 may determine the target object according to whether the image features of one of the candidate foreground objects in the input images matches with the image features of the shape/color/outline of one of the pre-stored objects.

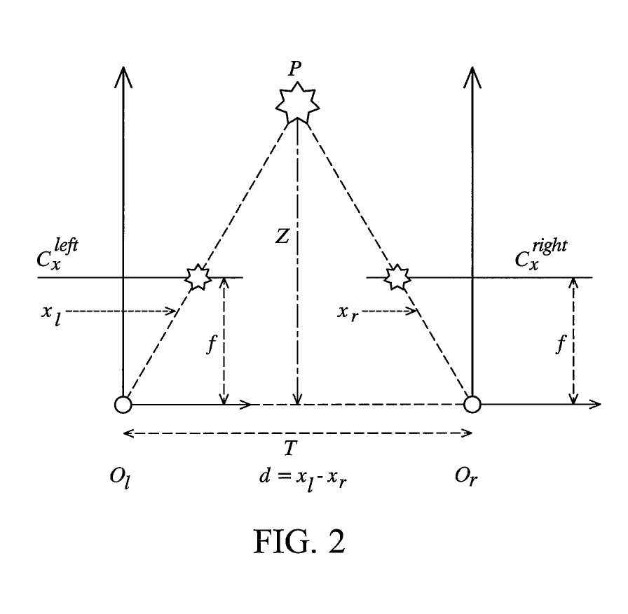

As illustrated in FIG. 2, Oₗ and Oᵣ are the horizontal positions of the left camera and the right camera. The imaging of the dual cameras can be expressed as the following triangulation equations:

$$\frac{T - ( {x}_{l} - {x}_{r} )}{Z - f} = \frac{T}{Z} ; and$$

$$Z = \frac{fT}{{x}_{l} - {x}_{r}} = \frac{fT}{d} ,$$

where T is the horizontal distance between the camera and the center of camera lenses, Z is the depth distance between the middle point of the dual cameras and the object P, f is the focal length of the camera, xₗ and xᵣ are the horizontal position of the object P observed by the left camera and the right camera with the focal length f, and d is the distance between the horizontal position xₗ and xᵣ.

Generally, because the distance between the camera lens and the target object may vary in several 2D images, the size of the area or the feature points of the target object in the 2D images may correspondingly vary. The target object is retrieved difficultly. The present invention can automatically calculate the world coordinate area Aᵣₑₐₗ of the target object in the 2D image with the specific depth Z according to the relationship between the area and the depth of the foreground object, and select the target object from all the detected candidate foreground objects in the 2D image according to if the area of each of candidate foreground objects with the specific depth Z matches the real area Aᵣₑₐₗ respectively. The relationship between the area and the depth of the foreground object can be expressed as following:

$${A}_{Real} \approx {A}_{Down} + \frac{Z - {Z}_{Down}}{{Z}_{Up} - {Z}_{Down}} \times ( {A}_{Up} - {A}_{Down} ) ,$$

where Aᵣₑₐₗ is the real area of the object in the 2D image, Zᵤₚ and Z_{down} is the maximum and minimum depth value of the dual cameras, respectively, Aᵤₚ and A_{down} are the areas of the target object in the 2D image under the depth Zᵤₚ and Z_{down} respectively, and Z is the depth of the candidate target object.

In another embodiment, according to the triangle proportion relationship formula, the observed area of the target object in the 2D image is larger when the distance between the target object and the camera is closer, and the observed area of the target object in the 2D image is smaller when the distance between the target object and the camera is larger. This relationship can be applied to the calculation of areas, and the photographer can adjust the distance (e.g. the object depth Z) between the object and the camera for getting a pre-determined area of the object. Meanwhile, the processing unit 112 can select the candidate object with an area closest to the pre-determined area from the 2D image as the target object. If the object is partially covered while taking images, the processing unit 112 can correctly retrieve the target object by the information of the depth image and areas of various foreground objects.

In another embodiment, when amateur photographers take images, the target object usually occupies the major portion of the images. If the whole target object is transmitted to the image data server 120, it may cause a serious burden to the image data server 120 while matching image features. Meanwhile, a user can use a square window shown on the image to select a region with image features or a region of interest to transmit to the image data server 120 by using the specific buttons or functions in the mobile device 110. In one embodiment, the image data server 120 is coupled to the processing unit 112 through a serial data communications interface, a wired network, a wireless network or a communications network to receive the target object, but the invention is not limited thereto.

In one embodiment, as illustrated in FIG. 1, the image data server 120 further includes an image processing unit 121 and an image database 122. The image database 122 pre-stores a plurality of object image data and a plurality of corresponding object data. The plurality of object image data can be the image features corresponding to at least one pre-stored object, such as the area, shape, color, outline of the pre-stored object. The pre-stored objects can also be any possible object to be retrieved or some specific objects, such as a butterfly image database built for providing information of butterflies. The plurality of object data corresponding to the plurality of object image data can be at least one of texts, sounds, images, or films of each object image data, such as text files to introduce butterflies, images and sounds of a flying butterfly, or close-up photos of butterflies, but the invention is not limited thereto.

In another embodiment, the image processing unit 121 can obtain image features of the target object by a feature matching algorithm, and then map the image features of the target object to the object image data in the image database 122 to determine whether image features of the target object match with image features of one of the object image data. When matching, the image processing unit 121 retrieves the object data corresponding to the matching object image data from the image database 122 to be the retrieving data. Generally, determining whether the image features match one of the object image data indicates that whether a similarity between them exceeds a pre-determined value or whether the differences between them is within a specific range to be a matching result, is determined.

Further, the image processing unit 121 has to calculate the image features of the target object when map the image features of the target object to the object image data stored in the image database 122. However, in 2D images, the image features of the target object may vary with the position, angle, or rotation of the images, which is a kind of non-invariant property. In one embodiment, the image processing unit 121 uses a “Scale Invariant Feature Transform” (SIFT) feature matching algorithm to calculate the image features of the target object. Before mapping the image features of the target object to the object image data in the image database 122, the image processing unit 121 calculates the invariant features of the target object. The object image data are the retrieved image features corresponding to each image in the image database 122, and are pre-stored in the image database 122.

The methods for image features retrieving and matching include SIFT algorithms, template matching algorithms, and SURF algorithms, but the invention is not limited thereto.

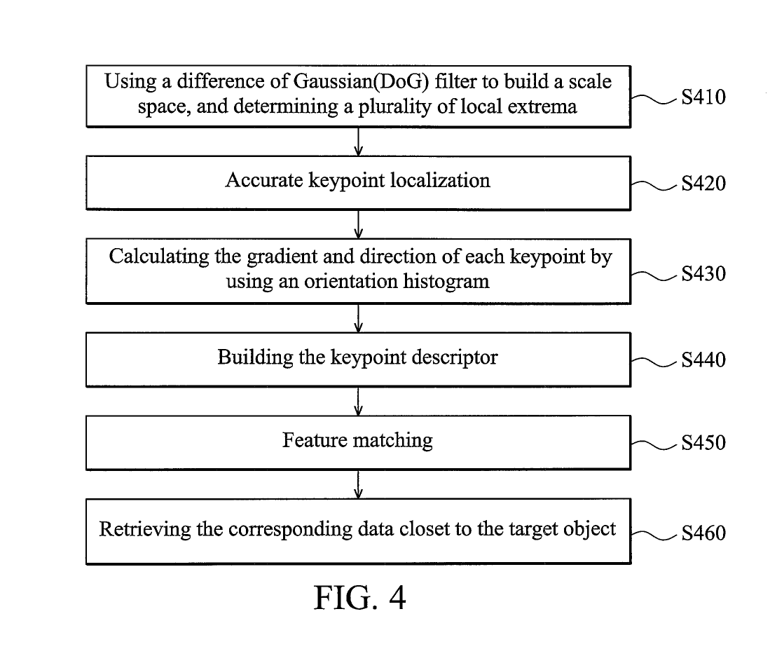

FIG. 4 illustrates the flowchart of the SIFT algorithm according to an embodiment of the invention. The SIFT algorithm uses the feature points of the image as the image features. In step S410, in one embodiment, the SIFT algorithm uses a difference of Gaussian (DoG) filter to build a scale space, and determines a plurality of local extrema, which can be the local maximum values or the local minimum values, to be feature candidates. In step S420, the SIFT algorithm distinguishes and deletes some local extrema which are unlikely to be image features, such as local extrema with low contrast or local extrema around edges, wherein this method is also called, accurate keypoint localization. For example, the method to distinguish the local extrema with low contrast can be expressed as the following three dimensional quadratic equation:

$$D ( x ) = D + \frac{\partial {D}^{T}}{\partial x} x + \frac{1}{2} {x}^{T} \frac{{\partial }^{2} D}{\partial {x}^{2}} x ; and$$

$$\hat{x} = - \frac{{\partial }^{2} {D}^{- 1}}{\partial {x}^{2}} \frac{\partial D}{\partial x} ,$$

where D is the result calculated by the DoG filter, x is the local extrema, and \hat{x} is a offset value. If the absolute value of \hat{x} is smaller than a pre-determined value, the local extrema corresponding to \hat{x} is the local extrema with low contrast.

In step S430, after retrieving the keypoints by using the accurate keypoint localization, the gradient and the direction of each keypoint are calculated, and an orientation histogram is used. The method of the orientation histogram uses the gradient orientation of each pixel within a window around each keypoint, and the orientation of most pixels within the window is the major orientation. The weight value of each pixel around the keypoint can be determined by multiplying the Gaussian distribution with the gradient of the pixel. The step S430 can also be regarded as orientation assignment.

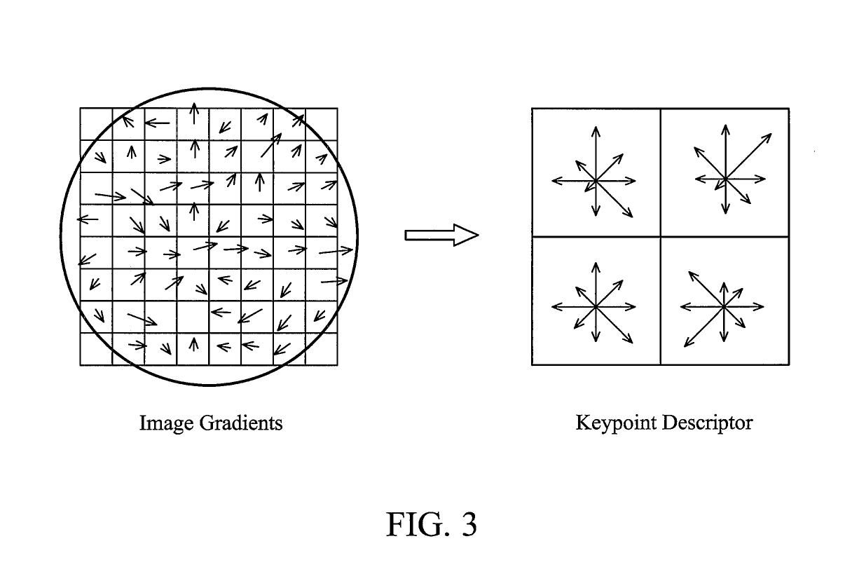

From the aforementioned steps S410 to S430, the location, value, and direction of each keypoint can be obtained. In step S440, the key point descriptor is built. The 8×8 window of each pixel in the target object is sub-divided into multiple 2×2 sub-windows. The orientation histogram of each 2×2 sub-window is summarized according to the method described in step S430 to determine the orientation of each 2×2 sub-window, which can be extended to corresponding 4×4 sub-windows. Therefore, there are 8 orientations in each 4×4 sub-window, which can be expressed as 8 bits, and there are 4×8=32 directions of each pixel, which can be expressed as 32 bits. As illustrated in FIG. 3, the picture can be regarded as a local image descriptor or a keypoint descriptor.

When the local image descriptor of the target object is obtained, feature matching can be performed with images in the image database 122 or the keypoint descriptors corresponding to each object. If a brute force matching method is used, it will consume a lot of resources for the amount of operations needed and time required. In one embodiment, in step S450, a K-D tree algorithm is adapted to perform feature matching between the keypoint descriptors of the target object and the keypoint descriptors of each image in the image database 122. The K-D tree algorithm builds a K-D tree for the keypoint descriptors corresponding to each image in the image database 122, and searches for k-nearest neighbors for each keypoint descriptor of each image, wherein k is an adjustable value. That is, for one keypoint descriptor, the k-nearest features can be set for each image, so that the relationship for feature matching between the keypoint descriptors of each image and other images can be built. When there is a new target object to be matched, the K-D tree method can be used to analyze the feature points of the new target object, and the object image data closest to the target object can be retrieved from the image database 122 quickly, and hence the amount of operations can be reduced to save time for searching.

In step S460, the corresponding data closet to the target object are retrieved. According to the retrieved image, the model type indexing and corresponding data links of the image closest to the target object can be obtained from the image database 122. Then, the image data server 120 can transmit the object data of the retrieved target object to the mobile device 110.

In one embodiment, the mobile device 110 further includes a display unit 113. When the mobile device 110 receives the retrieving data from the image data server 120, the processing unit 112 can display the retrieving data on the display unit 113. Further, the retrieving data can be displayed around the target object, or a specific location of the display unit 113. Meanwhile, the image capturing unit 111 can capture image sequences, wherein the processing unit 112 would continuously display the image sequences and the retrieving data on the display unit 113. In another embodiment, if the target object is a butterfly, the image database 122 can provide information or an introduction on the species of butterflies, or website links or other corresponding photos which correspond to the retrieving data, but the invention is not limited thereto.

The image retrieval method in one embodiment of the invention comprises:

Step 1: capturing an input image simultaneously and separately by the dual cameras (image capturing unit 112) of the mobile device 110;

Step 2: obtaining a depth image according to the input images, and determining a target object according to the image features of the input images and the depth image by the mobile device 110, wherein the image features can be at least one of information of the depth, area, template, shape, and topology features; and

Step 3: receiving the target object, obtaining retrieving data corresponding to the target object, and transmitting the retrieving data to the mobile device 110 by the image data server 120, wherein the image data server further includes an image database 122 for storing a plurality of object image data and a plurality of corresponding object data, and the object image data can be the texts, sounds, images or videos corresponding to each object image data.

The explanation of the mobile device 110, the image data server 120 and the related technologies in the above-mentioned steps is as mentioned earlier, and hence it will not be described again here.

The image retrieval method, or certain aspects or portions thereof, may take the form of program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The present invention also provides a computer program product for being loaded into a machine to execute an image retrieval method, which is suitable for dual cameras in a mobile device to capture an input image of an object. The computer program product comprises: a first program code, for obtaining a depth image according to the input images and determining a target object according to the input images and image features of the depth image; and a second program code, for retrieving the target object to obtain a retrieving data and transmitting the retrieving data to the mobile device.

The methods may also be embodied in the form of program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image retrieval system, comprising:
a mobile device, at least comprising:
an image capturing unit, having dual cameras for capturing an input image of an object simultaneously and separately; and
a processing unit, coupled to the image capturing unit, for obtaining a depth image according to the input images, and determining a target object according to image features of the input images and the depth image; and
an image data server, coupled to the processing unit, for receiving the target object, obtaining retrieving data corresponding to the target object, and transmitting the retrieving data to the mobile device.

2. The image retrieval system as claimed in claim 1, wherein the image features are information of at least one of the depth, area, template, shape, and topology features of the target object.

3. The image retrieval system as claimed in claim 2, wherein the image features at least include depth information, and the processing unit further normalizes the image features according to the depth information to determine the target object from the input images.

4. The image retrieval system as claimed in claim 1, wherein the image features is depth information and the processing unit can determine the target object from a foreground object appearing closest to the dual cameras in the depth image.

5. The image retrieval system as claimed in claim 1, wherein the image features at least includes depth information and area information, and the target object is a foreground object with an area and a depth within a predefined region in the depth image.

6. The image retrieval system as claimed in claim 1, wherein the image data server is coupled to the processing unit through a serial data communications interface, a wired network, a wireless network or a communications network to receive the target object.

7. The image retrieval system as claimed in claim 1, wherein the image data server further includes an image database for storing a plurality of object image data and a plurality of corresponding object data, wherein the plurality of object image data correspond to image features of at least one of pre-stored data, and the plurality of object data correspond to at least one data of texts, sounds, images, and videos of each of the plurality of object image data, respectively.

8. The image retrieval system as claimed in claim 7, wherein the image data server further includes an image processing unit for obtaining image features of the target image by a feature matching algorithm, and mapping to image features of the plurality of the object data to determine whether the target object matches one of the plurality of object image data, and when the target object matches one of the plurality of object image data, the image processing unit captures the plurality of object data corresponding to the determined object image data as the retrieving data.

9. The image retrieval system as claimed in claim 1, wherein the mobile device further includes a display unit for displaying the target object and the retrieving data when the mobile device receives the retrieving data.

10. The image retrieval system as claimed in claim 9, wherein when the image capturing unit captures image sequences, the display unit keeps displaying the image sequences and the retrieving data.

11. An image retrieval method, comprising:
capturing an input image of an object simultaneously and separately by dual cameras in a mobile device;
obtaining a depth image according to the input images, and determining a target object according to the input images and image features of the depth image by the mobile device; and
receiving the target object, obtaining retrieving data corresponding to the target object, and transmitting the retrieving data to the mobile device by an image data server.

12. The image retrieval method as claimed in claim 11, wherein the image features are information of at least one of the depth, area, template, shape, and topology features of the target object.

13. The image retrieval method as claimed in claim 12, wherein the image features at least include the depth information, and the image retrieval method further comprises:
normalizing the image features by the mobile device according to the depth information to determine the target object in the input images.

14. The image retrieval method as claimed in claim 11, wherein the image features are depth information, and the image retrieval method further comprises:
determining the target object from a foreground object appearing closest to the dual cameras in the depth image according to the depth information.

15. The image retrieval method as claimed in claim 11, wherein the image features of the depth image at least include depth information and area information, and the target object is a foreground object with an area and a depth within a predefined region in the depth image.

16. The image retrieval method as claimed in claim 11, wherein the image data server further includes an image database for storing a plurality of object image data and a plurality of corresponding object data, wherein the plurality of object image data correspond to one of image information of at least one of pre-stored data, and the plurality of object data correspond to data of at least one of texts, sounds, images, and videos of each of the plurality of object image data, respectively.

17. The image retrieval method as claimed in claim 11, further comprising:
obtaining image features of the target object by a feature matching algorithm by the image data server;
mapping the image features of the target object to image features of the plurality of object image data to determine whether the target object matches one of the plurality of object image data; and
capturing the matching one of plurality of object data from the image database as the retrieving data when the target object matches one of the plurality of object image data.

18. The image retrieval method as claimed in claim 11, further comprising:
displaying the target object and the retrieving data on a display unit in the mobile device when the mobile device receives the retrieving data.

19. The image retrieval method as claimed in claim 18, further comprising: displaying image sequences and the retrieving data continuously on the display unit when the mobile device captures the image sequences.

20. A computer program product for being loaded into a machine to execute an image retrieval method, which is suitable to be applied in a mobile device, which is incorporated with dual cameras to capture an input image of an object, wherein the computer program product comprises:
a first program code, for obtaining a depth image according to the input images and determining a target object according to the input images and image features of the depth image; and
a second program code, for retrieving the target object to obtain retrieving data and transmitting the retrieving data to the mobile device.
